(19) United States
(12) Patent Application Publication
(10) Pub. No.: US 2010/0071238 A1
(43) Pub. Date: Mar. 25, 2010

(54) LED DYNAMIC ADVERTISING LAMP BOX AND METHOD FOR MAKING SAME

(76) Inventor: Mingjie Guo, Shanghai (CN)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/517,045

(22) PCT Filed: Nov. 30, 2007
(86) PCT No.: PCT/CN07/03384

§ 371 Date: May 29, 2009

(30) Foreign Application Priority Data
Dec. 1, 2006 (CN) 200610118961.8
Dec. 1, 2006 (CN) 200620048393.4

(51) Int. Cl. G09F 9/33; G09F 9/302; G09F 13/04; G09F 13/10; B23P 17/04; B26D 7/00

(52) U.S. Cl. 40/463; 29/592; 83/23

(57) ABSTRACT

A LED dynamic advertising lamp box with animated visual effects, comprising an outer frame, a light-emitting advertising board, a program controller, and a power supply; the light-emitting advertising board comprises a surface layer composed of advertising pictures, an overall background light guide board, and several shape light guide boards. As per specific requirements, the advertising screen can either emit light as a whole, or flash different picture or text areas and emit light according to a certain sequence. In addition, LED light sources can be reasonably combined with pre-treated transparent acryl boards to form an overall background light guide board and shape light guide boards that match the shapes of pictures or text on the advertising screen. At the same time, color changes of LED lights and control by the program controller add dynamic effects and stepping effects to the visual effects of the plane advertisement and offer animated changes according to a certain sequence to attract the audience. Such visual effects not only make the pictures in the advertising lamp box more attractive to customers, but also lead to better advertising effects. Besides, the advertising lamp box in this invention has retained the features of traditional new-style ultra-thin lamp boxes that are easy to use and handle.

### TECHNICAL FIELD

The present invention relates to an advertising lamp box, in particular to an LED dynamic advertising lamp box with animated visual effects and method for making it.

### BACKGROUND

Besides audio and video media, such as TV, radio and movie, as well as paper-based carriers such newspapers and magazines, advertising signboard is one of the most important and well-known advertisement carriers in the advertising industry today. Among most common advertising signboards, advertising lamp boxes account for a large proportion as an advertisement carrier. With the coming out of various new advertising lamp boxes, they have occupied the largest share in the market. Most of existing advertising lamp boxes are equipped with lighting lamp inside the lamp boxes inside so that they remain bright under different environmental conditions. Their advertising effects are not restricted by external light. Besides, advertising lamp boxes provide more vivid pictures compared with other forms of advertising signboards.

However, existing advertising lamp boxes in the current market have some limitations in their application technology and presentation effects. They commonly have the following disadvantages: 1. advertising lamp boxes usually have relatively monotonous pictures. Due to the limited vision of the audience, they fails to transfer some product information that advertisers want to convey to the audience most; 2. Pictures in the lamp boxes do not have dynamic visual effects. Pictures installed inside are stationary. Rolling pictures are the best they could do to achieve the changing effects. Such changing effects cannot fully present the contents of advertisements or convey what they want to deliver to the audience. Besides, since these advertising lamp boxes do not have strong visual impacts, the optimum advertising effects cannot be obtained.

### DESCRIPTION OF THE INVENTION

The first aspect of this invention is to provide an LED dynamic advertising lamp box with animated visual effects.

The second aspect of this invention is to provide a method for fabricating the LED dynamic advertising lamp box mentioned above.

As the first aspect of this invention, the LED dynamic advertising lamp box with animated visual effects comprises:

A lamp box, and

A light-emitting advertising board on the surface of said lamp box that faces the audience, and

A power supply installed in said lamp box. The conducting wires of the power supply are led out of the lamp box and connected to commercial power through a power adapter, characterized in that:

It also comprises a program controller of which power-feeding end is connected to the power supply, moreover, said light-emitting advertising board comprises:

A surface layer containing an advertising screen; Said advertising screen contains at least one picture or text area used to display the contents of the advertisement;

A first light guide board to the front of which the surface layer is adhered;

A first reflective membrane adhered to the back of the first light guide board. At least one first stencil area of which position and shape are in accordance with the picture or text area on the surface layer is carved out on the first reflective membrane;

At least one second light guide board set up behind said first light guide board and in the at least one first stencil area of said first reflective membrane. The shape of the second light guide board in the first stencil area should fit the shape of this first stencil area;

A second reflective membrane adhered to the back of the second light guide board;

Said program controller comprises at least one control module and driving modules that drive different light guide boards to emit light according to a certain program. The control module has a built-in driving program preset/predetermined according to the required flashing pattern of the advertising screen. By controlling different driving modules according to this driving program, the control module drives different light guide boards to emit light according to certain requirements and sequences.

This invention can have a second stencil area carved out on said second reflective membrane, and a third light guide board set up behind said second stencil area as needed by the advertising screen. Shape of the third light guide board behind the second stencil area should fit the shape of that second stencil area. A third reflective membrane is adhered to said third light guide board. This invention can also have a fourth light guide board and a fourth reflective membrane and a fifth light guide board and a fifth reflective membrane set up according to the principles described above, as needed by the advertising screen.

The first, second, and third light guide boards of this invention have different shapes but the same structure. All of them are composed of transparent acryl boards and first, second, and third LED light sources set up along edges on the sides of the transparent acryl boards. Driving modules of said program controller are first driving module, second driving module, and third driving module. The first driving module is connected to the first LED light source and drives the first LED light source to emit light. The second driving module is connected to the second LED light source and drives the second LED light source to emit light. The third driving module is connected to the third LED light source and drives the third LED light source to emit light.

Concave lines are carved or convex lines are printed on the backs of said transparent acryl boards so that light sent out by transparent lighting boards is even and gentle. Axes of said lines are perpendicular to the light axes of said LED light sources. And the arrangement density of said lines will increase with their distances from LED light sources.

Concave spots are struck out or convex spots are printed on the backs of said transparent acryl boards so that light sent out by light guide boards is even and gentle. And the arrangement density of said concave or convex spots will increase with their distances from LED light sources. Said concave or convex spots can be regularly or randomly arrayed.

LED light sources can be white LED light sources or monochromatic LED light sources of different colors as needed by pictures or text areas on the advertising screen. They can also be controlled by the program controller to emit light of different colors.

LED light sources according to this invention can be driven by the program controller to perform many color changes. Said changes can be in a continuous or step-by-step manner.

The surface layer of said advertising screen can comprise only one film containing the advertising screen or comprise one film containing the advertising screen and a light-scattering membrane attached to the back of said film. The main purpose of said light-scattering membrane is to evenly distribute the light for the entire advertising screen.

This invention can also have a first transparent separating board set up between the first reflective membrane and the second light guide board, and a first light-tight layer set up on the back of said first separating board. A first light-transmitting area is set up on said first light-tight layer, matching both the shape and position of the first stencil area and said second light guide board. Said second light guide board is adhered to the back of the first light-transmitting area that matches the shape of the second light guide board.

This invention can also have a second transparent separating board set up between the second reflective membrane and the third light guide board and a second light-tight layer set up on the back of said second separating board. A second light-transmitting area is set up on said second light-tight layer, matching both the shape and position of the second stencil area and said third light guide board. Said third light guide board is adhered to the back of the second light-transmitting area that matches the shape of the third light guide board. A third separating board, a third light-tight layer, and a third light-transmitting area as well as corresponding fourth light guide board and fourth reflective membrane can also be set up according to the principles described above.

The first light-tight layer, the second light-tight layer, and the third light-tight layer described above can be black light-tight membranes adhered to the backs of the first separating board, the second separating board, and the third separating board, respectively, or black light-tight printing ink layers printed on the backs of the first separating board, the second separating board, and the third separating board, respectively.

As the second aspect of this invention, a fabrication method for the LED dynamic advertising lamp box with animated visual effects comprises the following steps:

1. Select an advertising picture film according to the customer's requirements;

2. Select acryl board material to make a first transparent acryl board used to post said advertising picture film according to the size of the advertising picture film;

3. Carve out concave lines or print convex lines and strike out concave spots or print convex spots on the back of the first transparent acryl board, and then adhere a first reflective membrane to the back of the first transparent acryl board. Carve out at least one first stencil area according to the position and shape of the picture or text area on the surface layer, and then install the first LED light source on the edge of one side of the first transparent acryl board to make the first light guide board;

4. Select acryl board material to make at least one second transparent acryl board according to the picture or text area on the surface layer as needed by the advertising screen. The shape of this second transparent acryl board also matches the shape of the first stencil area. Carve out concave lines or print convex lines and strike out concave spots or print convex spots on the back of the second transparent acryl board, and then adhere a second reflective membrane to the back of the second transparent acryl board. Finally install the second LED light source on the edge of the second transparent acryl board to make the second light guide board;

5. Adhere the advertising picture film to the front surface of the first light guide board, and then adhere the front surface of at least one second light guide board to the first stencil area on the back of the first light guide board. During adhering, the positions and shapes of the stencil area on the first reflective membrane and of the second light guide board should correspond to and match the position and shape of the picture or text area on the advertising screen to form the entire light-emitting advertising board;

6. Fabricate the program controller, and compile the driving program according to the light-emitting and flashing requirements or the position and shape of the picture or text area on the advertising screen and according to the light-emitting sequence of the first light guide board and several second light guide boards. Then write the compiled driving program into the control module of the program controller;

7. Fabricate the outer frame of the lamp box. Installed the light-emitting advertising board prepared onto the side of the outer frame that faces the audience. Then the conducting wires of the first LED light source on the first light guide board and the second LED light sources on the different second light guide boards are connected to the electric interfaces of different driving modules in the program controller. Finally close the lamp box.

The method of this invention also includes: fabricating a light-scattering membrane, adhering the light-scattering membrane to the back of the advertising picture film, and then adhering the back of the light-scattering membrane to the front surface of the first light guide board, if it is needed by the advertising screen; of course, the light-scattering membrane can also be directly adhered to the front surface of the first light guide board.

This invention can also have a second stencil area carved out on said second light-scattering membrane as needed by the advertising screen. And acryl board material can be selected to fabricate the third transparent acryl board as needed by the advertising screen. The shape of the third transparent acryl board matches the shape of the second stencil area. Carve out concave lines or print convex lines and strike out concave spots or print convex spots on the back of the third transparent acryl board, and then adhere a third reflective membrane to the back of the third transparent acryl board. Finally install the third LED light source on the edge of the third transparent acryl board to make the third light guide board. Connect the conducting wire of the third LED light source of the third light guide board to the electric interface of the driving module in the program controller.

This invention can also have a fourth transparent acryl board and a fourth reflective membrane and a fifth transparent acryl board and a fifth reflective membrane set up according to the principles described above, as needed by the advertising screen.

Axes of said lines are perpendicular to the light axes of said LED light sources. And the arrangement density of said lines will increase with their distances from LED light sources.

The arrangement density of said concave or convex spots will increase with their distances from LED light sources. Said concave or convex spots can be regularly or randomly arrayed.

This invention can also have a first transparent separating board set up between the first reflective membrane and the second light guide board and a first light-tight layer set up on the back of said first separating board. A first light-transmitting area is set up on said first light-tight layer, matching both the shape and position of the first stencil area and the shape of said second light guide board. Said second light guide board is adhered to the first light-transmitting area that corresponds to the shape of the second light guide board.

This invention can also have a second transparent separating board set up between the second reflective membrane and the third light guide board and a second light-tight layer set up on the back of said second separating board. A second light-transmitting area is set up on said second light-tight layer, matching both the shape and position of the second stencil area and said third light guide board. Said third light guide board is adhered to the back of the second light-transmitting area that matches the shape of the third light guide board. A third separating board, a third light-tight layer, and a third light-transmitting area as well as corresponding fourth light guide board and fourth reflective membrane can also be set up according to the principles described above.

The first light-tight layer, the second light-tight layer, and the third light-tight layer described above can be black light-tight membranes adhered to the backs of the first separating board, the second separating board, and the third separating board, or black light-tight printing ink layers printed on the backs of the first separating board, the second separating board, and the third separating board.

As per specific requirements, the advertising screen can either emit light as a whole, or flash different picture or text areas and emit light according to a certain sequence. In addition, LED light sources can be reasonably combined with pre-treated transparent acryl boards to form the first light guide board and the second, third, fourth, and even fifth light guide boards that match the pictures or text on the advertising screen. At the same time, color changes of LED lights and control by the program controller add dynamic effects and stepping effects to the visual effects of the plane advertisement and offer animated changes according to a certain sequence to attract the audience. Such visual effects not only make the pictures in the advertising lamp box more attractive to customers, but also lead to better advertising effects. Besides, the advertising lamp box according to this invention has retained the features of tradition new-style ultra-thin lamp boxes that are easy to use and handle.

### DESCRIPTION OF FIGURES

This invention will be further described with the following figures and embodiments.

FIG. 1 is a schematic view of the exterior appearance of the LED dynamic advertising lamp box of this invention.

FIG. 2 is a schematic view of the structure of the light-emitting advertising board of this invention.

FIG. 3 is a schematic view of the structure of a first transparent acryl board of this invention.

FIG. 4 is a schematic view of the structure of another first transparent acryl board of this invention.

FIG. 5 is a schematic view of the structure of the first reflective membrane of this invention.

FIG. 6 is a schematic view of the structure of the first separating board of this invention.

FIG. 7 is a schematic view of the structure of the first light-tight of this invention.

FIG. 8 is a schematic view of the structure of the overall background light guide board formed by attaching the first reflective membrane to the first transparent acryl board as shown in FIG. 3.

FIG. 9 is a schematic view of the structure of a second transparent acryl board of this invention.

FIG. 10 is a schematic view of the structure of another second transparent acryl board of this invention.

FIG. 11 is a schematic view of the structure of the light guide board formed by attaching the second reflective membrane to the second transparent acryl board as shown in FIG. 9.

FIG. 12 is a schematic view of the circuit connection between the program controller and LED light sources of this invention.

FIG. 13 is a view of the visual effects of this invention.

### PREFERRED EMBODIMENTS

This invention will be further described with detailed pictures so that the technical approaches, creative features, purposes, and effects of this invention can easily understood.

An LED dynamic advertising lamp box with animated visual effects, comprising a lamp box, a light-emitting advertising board, a program controller, and a power supply; As shown in FIG. 1, the lamp box of this invention has an Outer Frame 100 and a bottom plate (not shown). The bottom plate of the lamp box is installed on Outer Frame 100 with screw nails and fastening pieces in a removable manner. The bottom plate of the lamp box can be removed to offer access to component parts in the lamp box. A Ventilating Hole 110 can be opened on Outer Frame 100 to provide an outlet for the heat inside the lamp box.

A Light-emitting Board 200 is installed on the side of Outer Frame 100 that faces the audience. A program controller and a power supply (not shown) are installed in appropriate positions inside the lamp box. Conducting Wire (300) of the power supply is led out of the lamp box and connected to commercial power. The program controller is connected to the power supply.

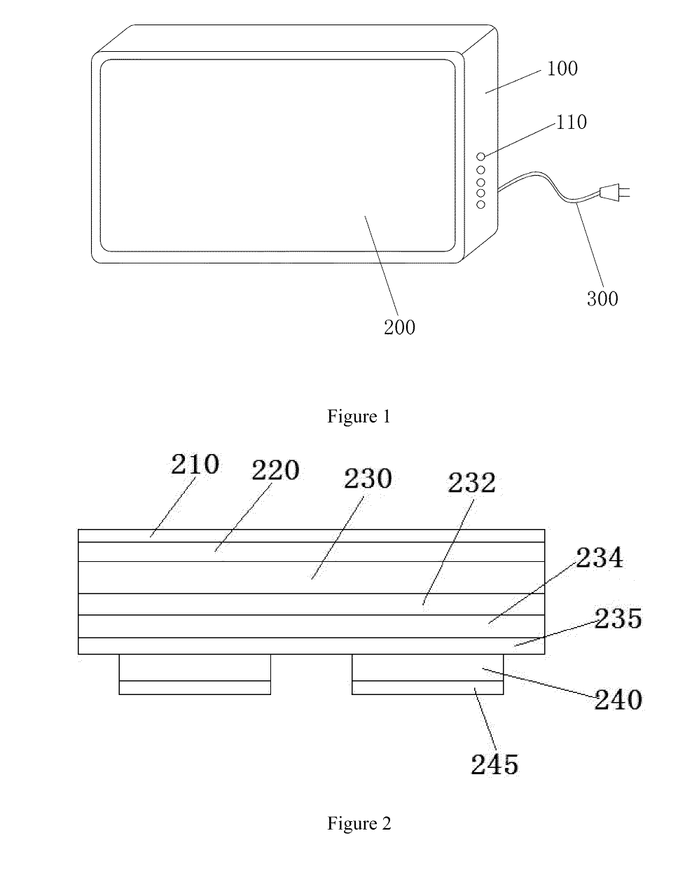

As shown in FIG. 2, Light-emitting Board 200 has a surface layer containing Advertising Screen 210 and Light-scattering Membrane 220, an Overall Background Light Guide Board 230, and several Shape Light Guide Boards 240. As a matter of fact, Light-scattering Membrane 220 can be optional in the actual manufacturing process.

The structure, fabrication method, and working principles of this invention will be detailed with an advertisement of a Chinese yellow wine brand named “Golden Age”.

As shown in FIG. 13A, the film of Advertising Screen 210 of “Golden Age” Chinese yellow wine comprises a “Harmonious Wine” Text Area 211, a Bottle Picture Area 212, a “Golden Age” Artistic Text Area 213, a “Having Dreams” Text Area 214, a “Having Friends” Text Area 214, and a “Nutritional Yellow Wine” Text Area 216. These picture and text areas make up the entire Advertising Screen 210. In the light-emitting mode of existing advertising lamp boxes, the entire advertising screen will emit light as a whole. In dim ambient light, the advertising screen can still be visible to the audience. But “Harmonious Wine” Text Area 211, Bottle Picture Area 212, “Golden Age” Artistic Text Area 213, “Having Dreams” Text Area 214, “Having Friends” Text Area 214, and “Nutritional Yellow Wine” Text Area 216 cannot be flashed independently or according to a certain sequence. Therefore the advertising effect is not quite satisfactory. Through a combination of Overall Background Light Guide Board 230 and four Shape Light Guide Boards 250, this invention can make different areas in Advertising Screen 210 flash independently or according to a certain sequence to improve the advertising effects.

As shown in FIG. 2, a Light-scattering Membrane 220 is attached to the back of the film of Advertising Screen 210 to form the surface layer of the advertising lamp box. Light-scattering Membrane 220 can be optional in the actual manufacturing process.

The main purpose of Light-scattering Membrane 220 is to evenly distribute the light of the entire advertising screen by scattering light. There are many methods to attach Light-scattering Membrane 220 to the film of Advertising Screen 210, such as gluing.

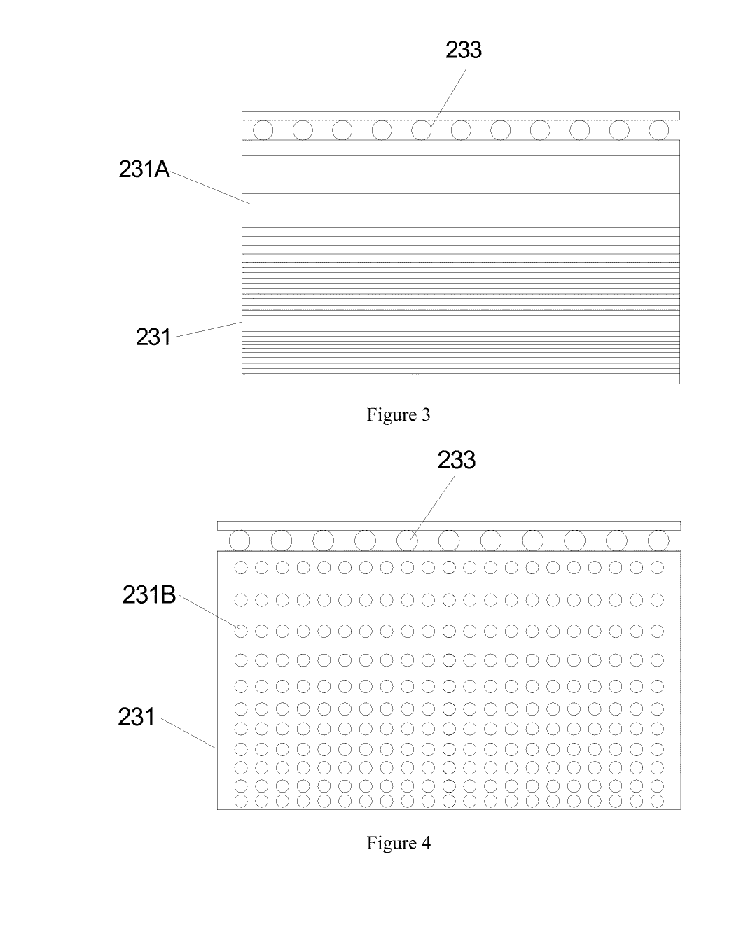

The back of this surface layer is adhered to the front surface of Overall Background Light Guide Board 230 as shown in FIG. 3. Overall Background Light Guide Board 230, i.e. the first light guide board, comprises a First Transparent Acryl Board 231, size of which matches the size of Advertising Screen 210, a First LED Light Source 233 installed on one edge of the First Transparent Acryl Board 231, the First Reflective Membrane 232, the First Separating Board, and the First Light-tight Layer 235. The First LED Light Source 233 comprises several white LED diodes. When the First LED Light Source 232 is turned on, the entire Advertising Screen 210 will have the effects shown in the plane effect diagram of FIG. 13A.

As shown in FIG. 3, the First Transparent Acryl Board 231 is made of acryl board material (common practice in the industry). Concave Lines 231A are carved out or Convex Lines 231A are printed on the back of the First Transparent Acryl Board 231. The purpose of these Lines 231A is to evenly distribute the illumination on the surface of the First Transparent Acryl Board 231.

In particular, axes of carved Concave Lines 231A or printed Convex Lines 231A are perpendicular to the light axis of the First LED Light Source 233, and their arrangement density increase with their distance from the First LED Light Source 233. This is mainly because that the closer to the First LED Light Source 233, the stronger the light becomes. Therefore Lines 231A closer to the light source can be less concentrated. And the farther from the First LED Light Source 233, the weaker the light becomes. Therefore Lines 231A farther from the light source can be more concentrated.

As shown in FIG. 4, the First Transparent Acryl Board 231 is made of acryl board material (common practice in the industry). Concave Spots 231B are struck out or Convex Spots 231B are printed by laser on the back of the First Transparent Acryl Board 231. The purpose of these Spots 231A is to evenly distribute the illumination on the surface of the First Transparent Acryl Board 231. In particular, the arrangement density of Concave or printed Convex Spots 231B will increase with their distances from the First LED Light Source 233. This is mainly because that the closer to the First LED Light Source 233, the stronger the light becomes. Therefore Concave or printed Convex Spots 231B closer to the light source can be less concentrated. And the farther from the First LED Light Source 233, the weaker the light becomes. Therefore Concave or printed Convex Spots 231B farther from the light source can be more concentrated.

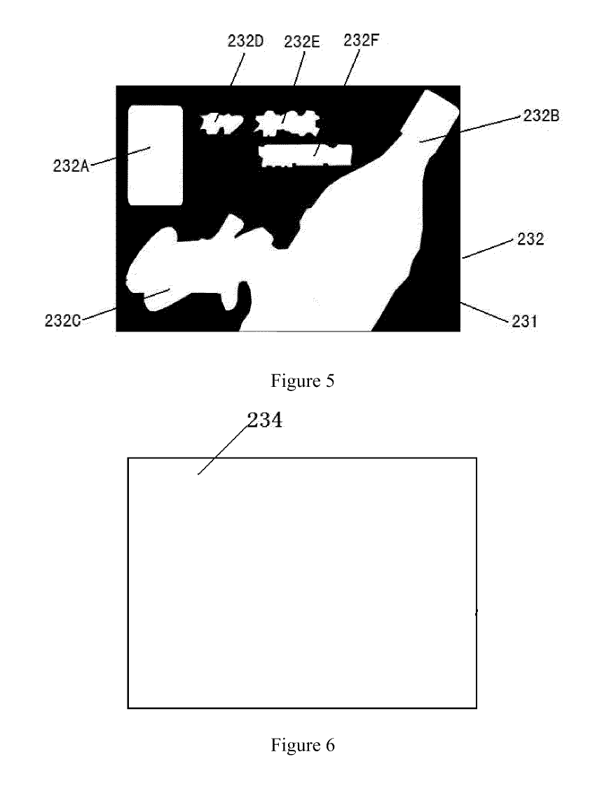

As shown in FIG. 5 and FIG. 6, the First Reflective Membrane 232 is adhered to the back of the First Transparent Acryl Board 231 shown in FIG. 3 to evenly distribute the light. There are six first stencil areas set up on the First Reflective Membrane 232, namely 232A, 232B, 232C, 232D, 232E, and 232F. The position and shape of the First Stencil Area 232A match the position and shape of “Harmonious Wine” Text Area 211 on the Advertising Screen 210, the position and shape of the First Stencil Area 232B match the position and shape of Bottle Picture Area 212 on the Advertising Screen 210, the position and shape of the First Stencil Area 232C match the position and shape of “Golden Age” Artistic Text Area 213 on the Advertising Screen 210, the position and shape of the First Stencil Area 232D match the position and shape of “Having Dreams” Text Area 214 on the Advertising Screen 210, the position and shape of the First Stencil Area 232E match the position and shape of “Having Friends” Text Area 215 on the Advertising Screen 210, and the position and shape of the First Stencil Area 232F match the position and shape of “Nutritional Yellow Wine” Text Area 216 on the Advertising Screen 210.

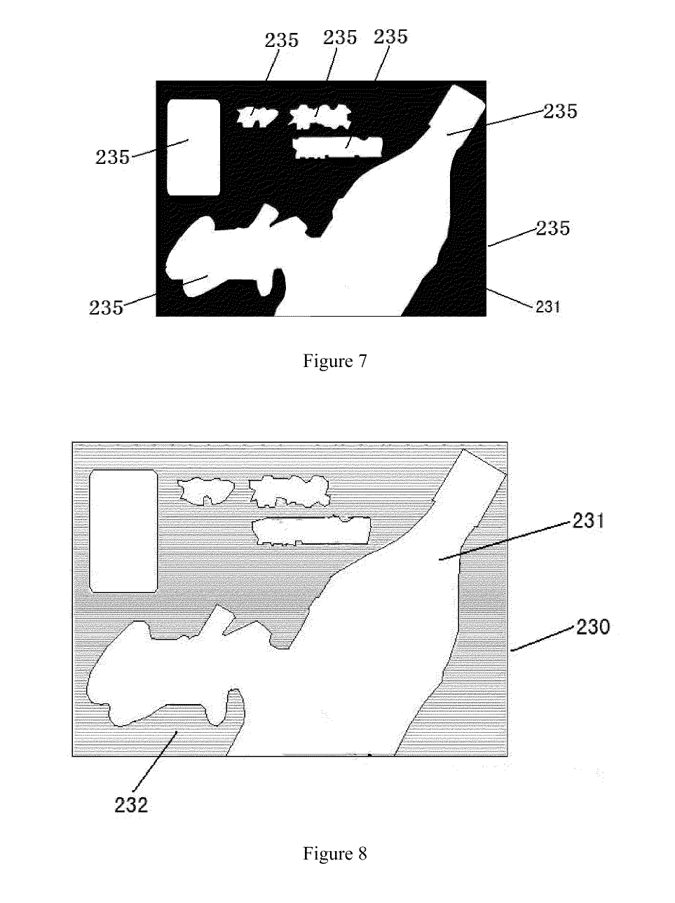

As shown in FIG. 7, the First Separating Board 234 is a transparent board. As shown in FIG. 8, the First Light-tight Layer 235 can be a black light-tight membrane adhered to the back of the First Separating Board 234 or a black light-tight printing ink layer printed on the back of the First Separating Board 234. There are six first light-transmitting areas set up on the First Light-tight Layer 235, namely 235A, 235B, 235C, 235D, 235E, and 235F. The position and shape of the First Light-transmitting Area 235A match the positions and shapes of both First Stencil Area 232A and “Harmonious Wine” Text Area 211 on the Advertising Screen 210, the position and shape of the First Light-transmitting 235B match the positions and shapes of both First Stencil Area 232B and Bottle Picture Area 212 on the Advertising Screen 210, the position and shape of the First Light-transmitting Area 235C match the positions and shapes of both First Stencil Area 232C and “Golden Age” Artistic Text Area 213 on the Advertising Screen 210, the position and shape of the First Light-transmitting Area 235D match the positions and shapes of both First Stencil Area 232D “Having Dreams” Text Area 214 on the Advertising Screen 210, the position and shape of the First Light-transmitting 235C match the positions and shapes of both First Stencil Area 232E and “Having Friends” Text Area 215 on the Advertising Screen 210, and the position and shape of the First Light-transmitting Area 235C match the positions and shapes of both First Stencil Area 232E and “Nutritional Yellow Wine” Text Area 216 on the Advertising Screen 210.

The front surface of the First Separating Board 234 is adhered to the back of the First Transparent Acryl Board 231 to form the entire first light guide board, i.e. Overall Background Light Guide Board 230.

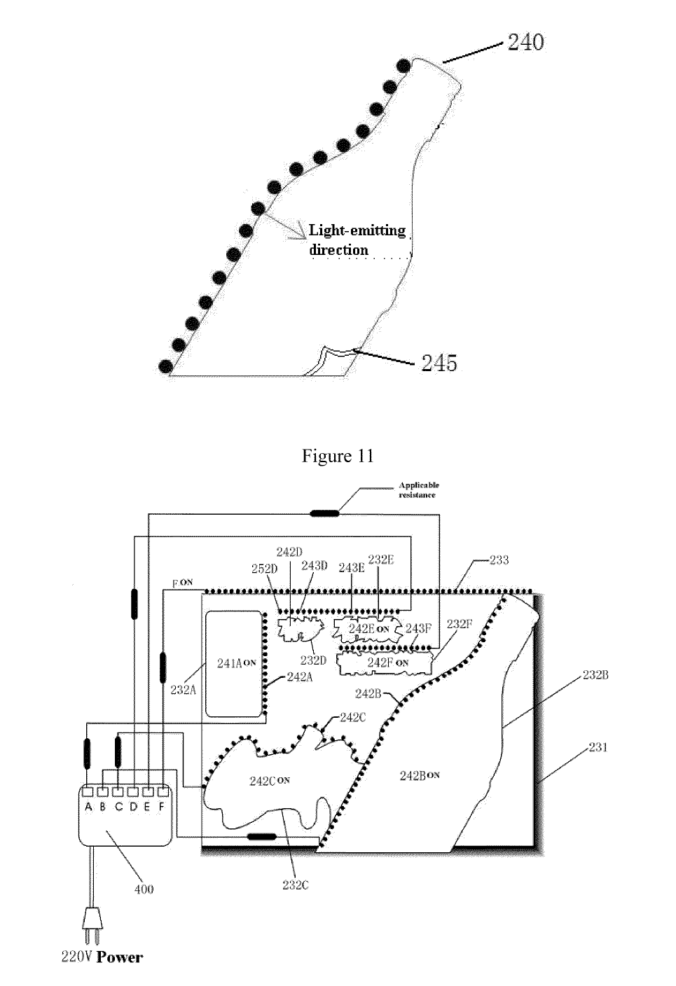

As shown in FIG. 2 and FIG. 11, six second light guide boards, i.e. Shape Light Guide Boards 240, are adhered to the back of the First Transparent Acryl Board 231. Each Shape Light Guide Board 240 is composed of a second transparent acryl board, a Second Reflective Membrane 245 adhered to the second transparent acryl board, and a second LED light source installed on the edge of the second transparent acryl board.

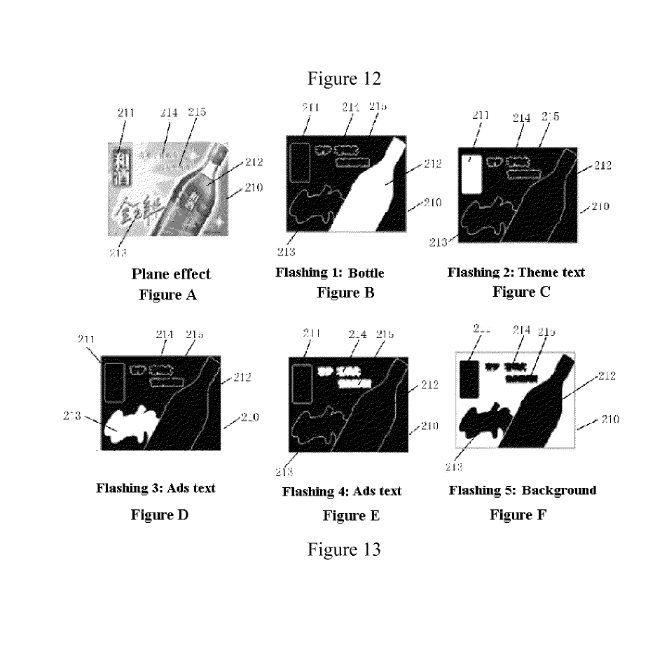

As shown in FIG. 12, the shape of the Second Transparent Acryl Board 241A matches the shape of “Harmonious Wine” Text Area 211 on Advertising Screen 210 and is adhered into the First Stencil Area 232A on the back of the First Transparent Acryl Board 231. Therefore, the position of the Second Transparent Acryl Board 241A matches the positions of both the First Stencil Area 232A and “Harmonious Wine” Text Area 211 on Advertising Screen 210.

The shape of the Second Transparent Acryl Board 242B matches the shape of the Bottle Picture Area 212 on Advertising Screen 210 and is adhered into the First Stencil Area 232B on the back of the First Transparent Acryl Board 231. Therefore, the position of the Second Transparent Acryl Board 242B matches the positions of both the First Stencil Area 232B and the Bottle Picture Area 212 on Advertising Screen 210.

The shape of the Second Transparent Acryl Board 242C matches the shape of “Golden Age” Artistic Text Area 213 on Advertising Screen 210 and is adhered into the First Stencil Area 232C on the back of the First Transparent Acryl Board 231. Therefore, the position of the Second Transparent Acryl Board 242C matches the positions of both the First Stencil Area 232C and “Golden Age” Artistic Text Area 213 on Advertising Screen 210.

The shape of the Second Transparent Acryl Board 242D matches the shape of “Having Dreams” Text Area 214 on Advertising Screen 210 and is adhered into the First Stencil Area 232D on the back of the First Transparent Acryl Board 231. Therefore, the position of the Second Transparent Acryl Board 242D matches the positions of both the First Stencil Area 232D and “Having Dreams” Text Area 214 on Advertising Screen 210.

The shape of the Second Transparent Acryl Board 242E matches the shape of “Having Friends” Text Area 215 on Advertising Screen 210 and is adhered into the First Stencil Area 232E on the back of the First Transparent Acryl Board 231. Therefore, the position of the Second Transparent Acryl Board 242E matches the positions of both the First Stencil Area 232E and “Having Friends” Text Area 215 on Advertising Screen 210.

The shape of the Second Transparent Acryl Board 242F matches the shape of “Nutritional Yellow Wine” Text Area 216 on Advertising Screen 210 and is adhered into the First Stencil Area 232F on the back of the First Transparent Acryl Board 231. Therefore, the position of the Second Transparent Acryl Board 242F matches the positions of both the First Stencil Area 232F and “Nutritional Yellow Wine” Text Area 216 on Advertising Screen 210.

Second LED Light Sources 243A, 243B, 243C, 243D, 243E, and 243F are respectively set up on the edges of Second Transparent Acryl Boards 242A, 242B, 242C, 242D, 242E, and 242F. Second LED Light Sources 243A, 243B, 243C, 243D, 243E, and 243F are monochromatic LED light sources. They can also be controlled by the program controller to emit light of different colors. Combined with the light emitted by the First LED Light Source 233 of the Overall Background Light-emitting Board 230, they can provide dazzling advertising effects.

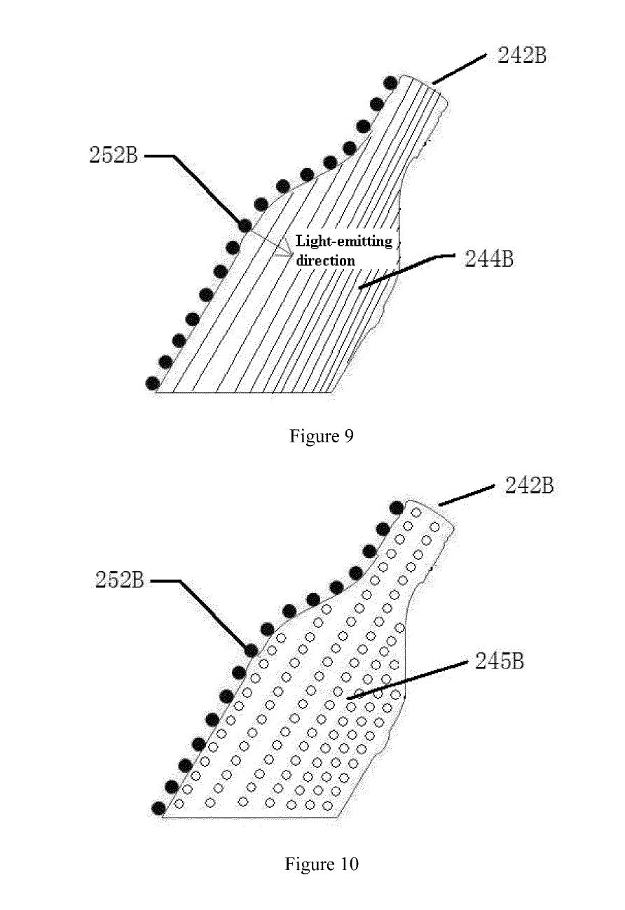

In order to achieve evenly distributed lighting of Second Transparent Acryl Boards 242A, 242B, 242C, 242D, 242E, and 242F, Concave Lines 244A are carved out or Convex Lines 244A are printed on the back of the Second Transparent Acryl Board 242B, as shown in FIG. 9. The purpose of these Lines 244A is to evenly distribute the illumination on the surface of the entire Second Transparent Acryl Board 242A. In particular, axes of carved Concave Lines 244A or printed Convex Lines 244A are perpendicular to the light axis of the Second LED Light Source 243A, and their arrangement density increase with their distance from the Second LED Light Source 243A. This is mainly because that the closer to the Second LED Light Source 243A, the stronger the light becomes. Therefore Lines 244A closer to the light source can be less concentrated. And the farther from the Second LED Light Source 243A, the weaker the light becomes. Therefore Lines 244A farther from the light source can be more concentrated.

As shown in FIG. 10, Concave Spots 245B are struck out or Convex Spots 245B are printed by laser on the back of the Second Transparent Acryl Board 242B. The purpose of these Concave or Convex Spots 245B is to evenly distribute the illumination on the surface of the Second Transparent Acryl Board 242B. In particular, the arrangement density of Concave Spots 245B struck out or Convex Spots 245B printed with laser will increase with their distances from the Second LED Light Source 243B. This is mainly because that the closer to the Second Light Source 243B, the stronger the light becomes. Therefore Concave or printed Convex Spots 245B closer to the light source can be less concentrated. And the farther from the Second LED Light Source 243B, the weaker the light becomes. Therefore Concave or printed Convex Spots 245B farther from the light source can be more concentrated.

Also, concave lines are carved out or convex lines are printed on the backs of Second Transparent Acryl Boards 242A, 242C, 243D, 243E, and 243F. Concave spots are struck out or convex spots are printed with laser on the backs of Second Transparent Acryl Boards 242A, 242C, 243D, 243E, and 243F.

As shown in FIG. 12, the Program Controller 400 comprises a control module (not shown) and six Driving Modules A, B, C, D, E, and F. Driving Module A is electrically connected to the Second LED Light Source 243A, driving Module B is electrically connected to the Second LED Light Source 243B, driving Module C is electrically connected to the Second LED Light Source 243C, driving Module D is electrically connected to the Second LED Light Source 243D, driving Module E is electrically connected to the Second LED Light Source 243E, and driving Module F is electrically connected to the First LED Light Source 233. The control module has a built-in driving program presetted according to the required flashing pattern of the advertising screen. By controlling different Driving Modules A, B, C, D, E, and F according to this driving program, the control module drives the First LED Light Source 233 and the Second LED Light Sources 243A, 243B, 243C, 243D, 243E and 243F to emit light according to certain requirements and sequences.

In this example, Program Controller 400 is connected to a 220V power supply through a power adaptor and converts it to 12V power suitable for LED. This program controller also connects suitable electric resistances to all connecting circuits of LED Light Sources A-F in a serial manner to achieve better control of the displaying effects of the advertising lamp box.

Electronic activating functions can also be set up in Program Controller 400 to control different Driving Modules A, B, C, D, E, and F to drive the First LED Light Source 233 and the Second LED Light Sources 243A, 243B, 243C, 243D, 243E and 243F to emit light of different colors and perform many color changes. Such changes can be in a continuous or step-by-step manner.

As shown in FIG. 13, the technical setup described above can achieve animated visual effects of the lamp box. First, Program Controller 400 turns on the First LED Light Source 233 through Driving Module F, and the entire Advertising Screen 210 will have the plane effects as shown in FIG. 13A. Then Program Controller 400 controls Driving Module B to drive the Second LED Light Source 243B to shine, and Bottle Picture Area 212 on Advertising Screen 210 shines (FIG. 13B). Then Program Controller 400 controls Driving Module A to drive the Second LED Light Source 243A to shine, and “Harmonious Wine” Text Area 211 on Advertising Screen 211 shines (FIG. 13C). Then Program Controller 400 controls Driving Module C to drive the Second LED Light Source 243C to shine, and “Golden Age” Artistic Text Area 213 on Advertising Screen 210 shines (FIG. 13D). Then Program Controller 400 controls Driving Module D and E to drive the Second LED Light Sources 243D, 243E, and 243F to shine, and “Having Dreams” Text Area 214, “Having Friends” Text Area 215, and “Nutritional Yellow Wine” Text Area 216 on Advertising Screen 211 shine (FIG. 13E). Then Program Controller 400 controls Driving Module F to drive the First LED Light Source 233 to shine, and the entire background of Advertising Screen 210 shines (FIG. 13F).

The fabrication method for the LED dynamic advertising lamp box described above comprises the following steps:

1. Select a suitable advertising screen film according to the customer's requirements. For example, the Advertising Screen 210 of a Chinese yellow wine brand named “Golden Age” comprises a “Harmonious Wine” Text Area 211, a Bottle Picture Area 212, a “Golden Age” Artistic Text Area 213, a “Having Dreams” Text Area 214, a “Having Friends” Text Area 215, and a “Nutritional Yellow Wine” Text Area 216.

2. Prepare a Light-scattering Membrane 200 of the same size as Advertising Screen 210 as needed by Advertising Screen 210. Then attach this Light-scattering Membrane 200 to the back of the film of Advertising Screen 210. As a matter of fact, Light-scattering Membrane 220 can be optional in the actual manufacturing process.

3. Select acryl board material according to the size of the film of Advertising Screen 210 to make the First Transparent Acryl Board 231 used in the Overall Background Light Guide Board. The First Transparent Acryl Board 231 has the same size as Advertising Screen 210. Carve out Concave Lines 231A or print Convex Lines 231A on the back of the First Transparent Acryl Board 231. The purpose of these Lines 231A is to evenly distribute the illumination on the surface of the First Transparent Acryl Board 231. In particular, axes of carved Concave Lines 231A or printed Convex Lines 231A are perpendicular to the light axis of the First LED Light Source 233, and their arrangement density increase with their distance from the First LED Light Source 233. This is mainly because that the closer to the First LED Light Source 233, the stronger the light becomes. Therefore Lines 231A closer to the light source can be less densely concentrated. And the farther from the First LED Light Source 233, the weaker the light becomes. Therefore Lines 231A farther from the light source can be more densely concentrated.

The First Transparent Acryl Board 231 is made of acryl board material (common practice in the industry). Strike out Concave Spots 231B or print Convex Spots 231B with laser on the back of the First Transparent Acryl Board 231. The main purpose of these Concave or printed Convex Spots 231B is to evenly distribute the illumination on the surface of the First Transparent Acryl Board 231. In particular, the arrangement density of Concave or printed Convex Spots 231B will increase with their distances from the First LED Light Source 233. This is mainly because that the closer to the First LED Light Source 233, the stronger the light becomes. Therefore Concave or printed Convex Spots 231B closer to the light source can be less concentrated. And the farther from the First LED Light Source 233, the weaker the light becomes. Therefore Concave or printed Convex Spots 231B farther from the light source can be more concentrated.

4. Cut out a First Reflective Membrane 232 of the same size as the First Transparent Acryl Board 231. The First Reflective Membrane 232 is a black membrane adhered to the back of the First Reflective Membrane 232 so that the entire background is clear. There are six first stencil areas set up on the First Reflective Membrane 232, namely 232A, 232B, 232C, 232D, 232E, and 232F. The position and shape of the First Stencil Area 232A match the position and shape of “Harmonious Wine” Text Area 211 on the Advertising Screen 210, the position and shape of the First Stencil Area 232B match the position and shape of Bottle Picture Area 212 on the Advertising Screen 210, the position and shape of the First Stencil Area 232C match the position and shape of “Golden Age” Text Area 213 on the Advertising Screen 210, the position and shape of the First Stencil Area 232D match the position and shape of “Having Dreams” Text Area 214 on the Advertising Screen 210, the position and shape of the First Stencil Area 232E match the position and shape of “Having Friends” Text Area 215 on the Advertising Screen 210, and the position and shape of the First Stencil Area 232F match the position and shape of “Nutritional Yellow Wine” Text Area 216 on the Advertising Screen 210. Adhere the First Reflective Membrane 232 to the back of the First Transparent Acryl Board 231, and then install the First LED Light Source 233 on one side of the First Transparent Acryl Board 231 to form the Overall Background Light Guide Board 230.

5. Cut out a First Transparent Separating Board 234 of the same size as the First Transparent Acryl Board 231 and adhere it to the back of the First Transparent Acryl Board 231.

6. Adhere a black light-tight membrane of printed black light-tight printing ink membrane to the back of the First Transparent Separating Board 234 to form a First Light-tight Layer 235. There are six first light-transmitting areas set up on the First Light-tight Layer 235, namely 235A, 235B, 235C, 235D, 235E, and 235F. The position and shape of the First Light-transmitting Area 235A match the positions and shapes of both First Stencil Area 232A and “Harmonious Wine” Text Area 211 on the Advertising Screen 210, the position and shape of the First Light-transmitting 235B match the positions and shapes of both First Stencil Area 232B and Bottle Picture Area 212 on the Advertising Screen 210, the position and shape of the First Light-transmitting Area 235C match the positions and shapes of both First Stencil Area 232C and “Golden Age” Text Area 213 on the Advertising Screen 210, the position and shape of the First Light-transmitting Area 235D match the positions and shapes of both First Stencil Area 232D “Having Dreams” Text Area 214 on the Advertising Screen 210, the position and shape of the First Light-transmitting 235C match the positions and shapes of both First Stencil Area 232E and “Having Friends” Text Area 215 on the Advertising Screen 210, and the position and shape of the First Light-transmitting Area 235C match the positions and shapes of both First Stencil Area 232E and “Nutritional Yellow Wine” Text Area 216 on the Advertising Screen 210.

7. Fabricate six Second Transparent Acryl Boards 242A, 242B, 242C, 242D, 242E, and 242F with acryl board material in one-to-one relations with the picture or text areas on the advertising screen according to the requirements on the advertising screen and flashing effects. Cave our concave Lines or print convex lines on the backs of the Second Transparent Acryl Boards 242A, 242B, 242C, 242D, 242E, and 242F. The purpose of these lines is to evenly distribute the illumination on the surfaces of the Second Transparent Acryl Boards 242A, 242B, 242C, 242D, 242E, and 242F. In particular, axes of carved concave lines or printed convex lines are perpendicular to the light axes of the Second LED Light Sources 243A, 243B, 243C, 243D, 243E, and 243F, and their arrangement density increase with their distance from the Second LED Light Sources 243A, 243B, 243C, 243D, 243E, and 243F. This is mainly because that the closer to the Second LED Light Sources 243A, 243B, 243C, 243D, 243E, and 243F, the stronger the light becomes. Therefore lines closer to the light sources can be less concentrated. And the farther from the Second LED Light Sources 243A, 243B, 243C, 243D, 243E, and 243F, the weaker the light becomes. Therefore lines farther from the light source can be more concentrated.

Strike out concave spots or print convex spots on the backs of Second Transparent Acryl Boards 243A, 243B, 243C, 243D, 243E, and 243F. The purpose of these concave or printed convex spots is to evenly distribute the illumination on the surfaces of the Second Transparent Acryl Boards 243A, 243B, 243C, 243D, 243E, and 243F. In particular, the arrangement density of concave spots or print convex spots will increase with their distances from the Second LED Light Sources 243A, 243B, 243C, 243D, 243E, and 243F. This is mainly because that the closer to the Second LED Light Sources 243A, 243B, 243C, 243D, 243E, and 243F, the stronger the light becomes. Therefore concave spots or print convex spots closer to the light sources can be less concentrated. And the farther from the Second LED Light Sources 243A, 243B, 243C, 243D, 243E, and 243F, the weaker the light becomes. Therefore concave spots or print convex spots farther from the light source can be more concentrated.

Attach a Reflective Membrane 245 to the backs of Second Transparent Acryl Boards 243A, 243B, 243C, 243D, 243E, and 243F. Then install the Second LED Light Sources 243A, 243B, 243C, 243D, 243E, and 243F on one sides of Second Transparent Acryl Boards 243A, 243B, 243C, 243D, 243E, and 243F to form six Shape Light-emitting Boards 240.

The shape of the Second Transparent Acryl Board 242A matches the shape of “Harmonious Wine” Text Area 211 on Advertising Screen 210 and is adhered into the First Stencil Area 232A on the back of the First Transparent Acryl Board 231. Therefore, the position of the Second Transparent Acryl Board 242A matches the position of “Harmonious Wine” Text Area 211 on Advertising Screen 210.

The shape of the Second Transparent Acryl Board 242B matches the shape of Bottle Picture Area 212 on Advertising Screen 210 and is adhered into the First Stencil Area 232B on the back of the First Transparent Acryl Board 231. Therefore, the position of the Shape Light Guide Board 251B matches the position of Bottle Picture Area 212 on Advertising Screen 210.

The shape of the Second Transparent Acryl Board 242C matches the shape of “Golden Age” Artistic Text Area 213 on Advertising Screen 210 and is adhered into the First Stencil Area 232C on the back of the First Transparent Acryl Board 231. Therefore, the position of the Second Transparent Acryl Board 242A matches the position of “Golden Age” Artistic Text Area 213 on Advertising Screen 210.

The shape of the Second Transparent Acryl Board 242D matches the shape of “Having Dreams” Text Area 214 on Advertising Screen 210 and is adhered into the First Stencil Area 232D on the back of the First Transparent Acryl Board 231. Therefore, the position of the Second Transparent Acryl Board 242D matches the position of “Having Dreams” Text Area 214 on Advertising Screen 210.

The shape of the Second Transparent Acryl Board 242E matches the shape of “Having Friends” Text Area 215 on Advertising Screen 210 and is adhered into the First Stencil Area 232E on the back of the First Transparent Acryl Board 231. Therefore, the position of the Second Transparent Acryl Board 242E matches the position of “Having Friends” Text Area 215 on Advertising Screen 210.

The shape of the Second Transparent Acryl Board 242F matches the shape of “Nutritional Yellow Wine” Text Area 216 on Advertising Screen 210 and is adhered into the First Stencil Area 232F on the back of the First Transparent Acryl Board 231. Therefore, the position of the First Stencil Area 232F matches the position of “Nutritional Yellow Wine” Text Area 216 on Advertising Screen 210.

8. Adhere the film of Advertising Screen 210 to the front surface of Light-scattering Membrane 220, adhere the back of Light-scattering Membrane 220 to the front surface of the First Transparent Acryl Board 231 in the Overall Background Light Guide Board 230, adhere the front surface of the First Separating Board 234 to the back of the First Transparent Acryl Board 231, and then adhere the Second Transparent Acryl Boards 243A, 243B, 243C, 243D, 243E, and 243F of the six Shape Light Guide Boards 240 into the First Light-transmitting Areas 235A, 235B, 235C, 235D, 235E, and 235F of the First Light-tight Layer 235 to form the entire Light-emitting Advertising Board 200.

9. Fabricate Program Controller 400, and compile the driving program according to the light-emitting and flashing requirements or the positions and shapes of the picture or text areas on the advertising screen and according to the light-emitting sequence of the Overall Background Light Guide Board 230 and six Shape Light Guide Boards 240. Then write the compiled driving program into the control module of the Program Controller 400.

10. Fabricate the Outer Frame 100 of the lamp box. Installed the Light-emitting Advertising Board 200 prepared onto the side of Outer Frame 100 that faces the audience. Then connect the conducting wires of the First LED Light Source 232 on the Overall Background Light Guide Board 230 and Second LED Light Sources 243A, 243B, 243C, 243D, 243E, and 243F in the six Shape Light Guide Boards 240 to the electric interfaces of Driving Modules F, A, B, C, D, and E in Program Controller 400. Finally close the lamp box.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiments and those alternatives which have been discussed above and all equivalent thereto

1. A LED dynamic advertising lamp box comprising:
A lamp box,
A light-emitting advertising board installed on the surface of said lamp box that face the audience, and
A power supply installed in said lamp box. The conducting wires of the power supply are led out of the lamp box and connected to commercial power through a power adapter, characterized in that:
The LED dynamic advertising lamp box also comprises a program controller, of which power-feeding end is connected to the power source. In addition,
Said light-emitting advertising board comprises:
One surface layer containing an advertising screen; Said advertising screen contains at least one picture or text area used to display the different contents of the advertisement;
A first light guide board to the front of which the surface layer is adhered;
The first reflective membrane adhered to the back of the first light guide board. At least one first stencil area, of which position and shape are in accordance with the picture or text area on the surface layer, is carved out on the first reflective membrane;
At least one second light guide board set up behind said first light guide board and in the at least one first stencil area of said first reflective membrane. The shape of the second light guide board in the first stencil area should fit the shape of the first stencil area;
A second reflective membrane adhered to the back of the second light guide board;
Said program controller comprises at least one control module and driving modules that drive different light guide boards to emit light according to a certain program. The control module has a built-in driving program preset according to the required flashing pattern of the advertising screen. By controlling different driving modules according to the driving program, the control module drives different light guide boards to emit light according to certain requirements and sequences.

2. The LED dynamic advertising lamp box according to claim 1, characterized in that: a second stencil area is carved out on said second reflective membrane, and it also comprise a third light guide board set up behind said second stencil area. The shape of the third light guide board behind the second stencil area matches the shape of the second stencil area; a third reflective membrane is adhered to the back of the third light guide board.

3. The LED dynamic advertising lamp box according to claim 1, characterized in that: a transparent first separating board is adhered to the back of said first reflective membrane. A first light-tight layer is set up on the back of said first separating board. Said first light-tight layer has a first light-transmitting area, of which position and shape are corresponding to the first stencil area and to the picture or text area on the surface layer. Said second light guide board is set up behind the first light-transmitting area. The shape of the second light guide board behind the first light-transmitting area matches the shape of the first light-transmitting area.

4. The LED dynamic advertising lamp box according to claim 2, characterized in that: a transparent second separating board is adhered to the back of said second reflective membrane. A second light-tight layer is set up on the back of said second separating board. Said second light-tight layer has a second light-transmitting area, of which position and shape are corresponding to the second stencil area. Said third light guide board is set up behind the second light-transmitting area. The shape of the third light guide board behind the second light-transmitting area matches the shape of the second light-transmitting area.

5. The LED dynamic advertising lamp box according to claim 3 characterized in that: said first and second light-tight layers are black light-tight membranes or printed black light-tight printing ink layers attached to the backs of the first and second separating boards.

6. The LED dynamic advertising lamp box according to claim 1, characterized in that: said first, second, and third light guide boards have different shapes but the same structure. All of them are composed of transparent acryl boards and the first, second, and third LED light sources set up along edges of the transparent acryl boards. Driving modules of said program controller are first driving module, second driving module, and third driving module. The first driving module is connected to the first LED light source and drives the first LED light source to emit light. The second driving module is connected to the second LED light source and drives the second LED light source to emit light. The third driving module is connected to the third LED light source and drives the third LED light source to emit light.

7. The LED dynamic advertising lamp box according to claim 6, characterized in that: concave lines are carved out or convex lines are printed on the backs of said transparent acryl boards.

8. The LED dynamic advertising lamp box according to claim 7, characterized in that: axes of said lines are perpendicular to the light axes of said LED light sources.

9. The LED dynamic advertising lamp box according to claim 7, characterized in that: the arrangement density of said lines increases with their distances from LED light sources.

10. The LED dynamic advertising lamp box according to claim 6, characterized in that: concave spots are struck out or convex spots are printed on the backs of said transparent acryl boards.

11. The LED dynamic advertising lamp box according to claim 10, characterized in that: the arrangement density of said concave or convex spots increases with their distances from LED light sources.

12. The LED dynamic advertising lamp box according to claim 10, characterized in that: said concave or convex spots are regularly arrayed.

13. The LED dynamic advertising lamp box according to claim 7, characterized in that: said concave or convex spots are irregularly arrayed.

14. The LED dynamic advertising lamp box according to claim 6, characterized in that: each of LED light sources can be white or monochromatic LED light sources as needed by picture or text areas on the advertising screen.

15. The LED dynamic advertising lamp box according to claim 6, characterized in that: each of LED light sources can be controlled by the program controller to emit light of different colors as needed by picture or text areas on the advertising screen.

16. The LED dynamic advertising lamp box according to claim 6, characterized in that: each of LED light sources can be driven by the program controller to perform many color changes.

17. The LED dynamic advertising lamp box according to claim 6, characterized in that: said changes can be in a step-by-step manner or a continuous manner.

18. The LED dynamic advertising lamp box according to claim 1, characterized in that: the surface layer of said advertising screen comprises a film containing the advertising pictures.

19. The LED dynamic advertising lamp box according to claim 1, characterized in that: the surface layer of said advertising screen comprises a film containing the advertising pictures and a light-scattering membrane attached to the back of said film.

20. A fabrication method for the LED dynamic advertising lamp box, comprising the following steps:
1). Select an advertising picture film according to the customer's requirements;
2). Select acryl board material to make the first transparent acryl board used to post said advertising picture film according to the size of the advertising picture film;
3). Carve out concave lines or print convex lines and strike out concave spots or print convex spots on the back of the first transparent acryl board, and then adhere a first reflective membrane to the back of the first transparent acryl board. Carve out at least one first stencil area according to the position and shape of the picture or text area on the surface layer, and then install the first LED light source along the edge of one side of the first transparent acryl board to form the first light guide board;
4). Select acryl board material to make at least one second transparent acryl board according to the picture or text area on the surface layer as need by the advertising screen. The shape of this second transparent acryl board also matches the shape of the first stencil area. Carve out concave lines or print convex lines and hit concave spots or print convex spots on the back of the second transparent acryl board, and then adhere a second reflective membrane to the back of the second transparent acryl board. Finally install the second LED light source along the edge of the second transparent acryl board to make the second light guide board;
5). Adhere the advertising picture film to the front surface of the first light guide board, and then adhere the front surface of at least one second light guide board to the first stencil area on the back of the first light guide board. During adhering, the positions and shapes of the stencil area on the first reflective membrane and of the second light guide board should correspond and match the position and shape of the picture or text area on the advertising screen to form the entire light-emitting advertising board;
6). Fabricate the program controller, and compile the driving program according to the light-emitting and flashing requirements or the position and shape of the picture or text area on the advertising screen and according to the light-emitting sequence of the first light guide board and several second light guide boards. Then write the compiled driving program into the control module of the program controller;
7). Fabricate the outer frame of the lamp box. Installed the light-emitting advertising board prepared onto the side of the outer frame that faces the audience. Then connect the conducting wires of the first LED light source on the first light guide board and the second LED light sources on the different second light guide boards to the electric interfaces of different driving modules in the program controller. Finally close the lamp box.

21. The method according to claim 20, characterized in that: it also includes fabricating a light-scattering membrane, adhering the light-scattering membrane to the back of the advertising picture film, and then adhering the back of the light-scattering membrane to the front surface of the first light guide board, as needed by the advertising screen.

22. The method according to claim 20, characterized in that: a second stencil area is carved out on said second light-scattering membrane. And acryl board material can be selected to fabricate the third transparent acryl board as needed by the advertising screen. The shape of the third transparent acryl board matches the shape of the second stencil area. Carve out concave lines or print convex lines and hit concave spots or print convex spots on the back of the third transparent acryl board, and then adhere a third reflective membrane to the back of the third transparent acryl board. Finally install the third LED light source on the edge of the third transparent acryl board to make the third light guide board. Connect the conducting wire of the third LED light source of the third light guide board to the electric interface of the driving module in the program controller.

23. The method according to claim 20, characterized in that: a transparent first separating board is set up on the back of said first reflective membrane. A first light-tight layer is set up on the back of said first separating board. Said first light-tight layer has a first light-transmitting area, of which position and shape are corresponding to the first stencil area and to the picture or text area on the surface layer. Said second light guide board is set up inside the first light-transmitting area. The shape of the second light guide board in the first light-transmitting area matches the shape of the first light-transmitting area.

24. The method according to claim 22, characterized in that: a transparent second separating board is adhered to the back of said second reflective membrane. A second light-tight layer is set up on the back of said second separating board. Said second light-tight layer has a second light-transmitting area, of which position and shape are corresponding to the second stencil area. The third light guide board is adhered into the second light-transmitting area.

25. The method according to claim 23, characterized in that: said first and second light-tight layers are black light-tight membranes or printed black light-tight printing ink layers attached to the backs of the first and second separating boards.

26. The method according to claim 20, characterized in that: axes of said lines are perpendicular to the light axes of said LED light sources.

27. The method according to claim 26, characterized in that: the arrangement density of said lines increase with their distances from LED light sources.

28. The method according to claim 20, characterized in that: the arrangement density of said concave or convex spots increase with their distances from LED light sources.

29. The method according to claim 28, characterized in that: said concave or convex spots can be regularly or irregularly arrayed.
